(19) United States
(12) Patent Application Publication
(10) Pub. No.: US 2013/0297450 A1
(43) Pub. Date: Nov. 7, 2013

(54) METHOD OF WITHDRAWAL OF FUNDS FROM BANK ACCOUNT TO PURCHASE RETAIL GIFT CARDS AND/OR ELECTRONIC RETAIL GIFT CODES GENERATING CASH REWARDS TO CONSUMER AND/OR REVENUE TO FINANCIAL INSTITUTION

(71) Applicant: SMARTYPIG, L.L.C., D.B.A. SOCIAL MONEY, West Des Moines, IA (US)

(72) Inventor: Jon M. Gaskell, II, West Des Moines, IA (US)

(73) Assignee: SmartyPig, L.L.C., d.b.a. Social Money, West Des Moines, IA (US)

(21) Appl. No.: 13/875,655

(22) Filed: May 2, 2013

Related U.S. Application Data
(60) Provisional application No. 61/641,333, filed on May 2, 2012.

(51) Int. Cl. G06Q 40/02; G06Q 30/06

(52) U.S. Cl. CPC G06Q 40/02; G06Q 30/06
USPC 705/26.35; 705/39

(57) ABSTRACT

A method of withdrawal of funds from a bank account to purchase retail gift cards and/or electronic retail gift codes generating cash rewards to consumer and/or revenue to financial institutions where the funds withdrawn from the bank account are used to purchase a retail gift card or electronic gift code at face value that was originally purchased at a discount generating a surplus in funds. The difference between the face value and discounted purchase price is divided into cash rewards for the consumer and revenue for the financial institution, at a percentage split determined by the financial institution.

### CROSS REFERENCE TO RELATED APPLICATION

This application claims the benefit of U.S. Provisional Application No. 61/641,333 filed May 2, 2012.

### BACKGROUND OF THE INVENTION

This invention is directed toward a method of withdrawing funds from a bank account to purchase retail gift cards and/or electronic retail gift codes, which generates cash rewards to consumers and/or revenue to the financial institution.

Online banking and savings continues to grow, as does the online shopping industry and online savings for specific purchases. Banks are also challenged to find new sources of revenue as their fee structures and regulations continue to change. While various savings programs are known in the art, utilizing these savings programs to purchase gift cards and electronic gift codes for retailers, while generating cash rewards for the consumer and revenue for the financial institution is challenging seeing as the financial institutions and retailers are independent entities and do not traditionally collaborate. Accordingly, there exists a need in the art for a method or system that addresses these deficiencies.

Therefore, an object of the present invention is to provide a method to customer withdrawal funds from a savings account to purchase a retail gift card or electronic gift code to a retailer.

A further objective of this invention is to provide a method where the purchase of this gift card creates a surplus of funds.

A still further objective of the present invention is a user interface to provide a method distribution of the surplus of funds as a cash back reward to consumers and revenue to the financial institution.

An even further objective of the invention is to allow the financial institution to determine the percentage of distribution of the funds between the customer as a cash reward and as the financial institution as revenue.

These and other objectives will be apparent to one skilled in the art based upon the following written description, drawings and claims.

### BRIEF SUMMARY OF THE INVENTION

The method of withdrawal of funds from a bank account to purchase retail gift cards and/or electronic retail gift codes generating cash rewards to consumer and/or revenue to financial institutions involves a consumer withdrawing funds from their bank account to purchase a retail gift card or electronic gift code at face value. Said gift card or electronic gift code is purchased by a third party at a discount, generating a surplus of funds. The surplus of funds is then distributed by the financial institution between the customer and itself as cash rewards to the customer and revenue to the financial institution.

The method of withdrawal of funds from a bank account to purchase retail gift cards and/or electronic retail gift codes generating cash rewards to consumer and/or revenue to financial institutions involves an online management software interface that allows the bank to determine the split of revenue to cash rewards based on the surplus of the gift card order. The user software interface has a customer engagement engine that permits the customers of the bank account to select the gift cards and/or electronic codes that it would like to purchase. The system of the two software interfaces enables a consumer of the bank to use funds in their savings account to purchase gift cards and online gift codes at face value that were originally purchased at a discount, ultimately generating a surplus of funds that can be divided into cash rewards and revenue.

### BRIEF DESCRIPTION OF THE DRAWINGS

FIG. 1 is a schematic view of an environment for a method of purchasing a gift; and

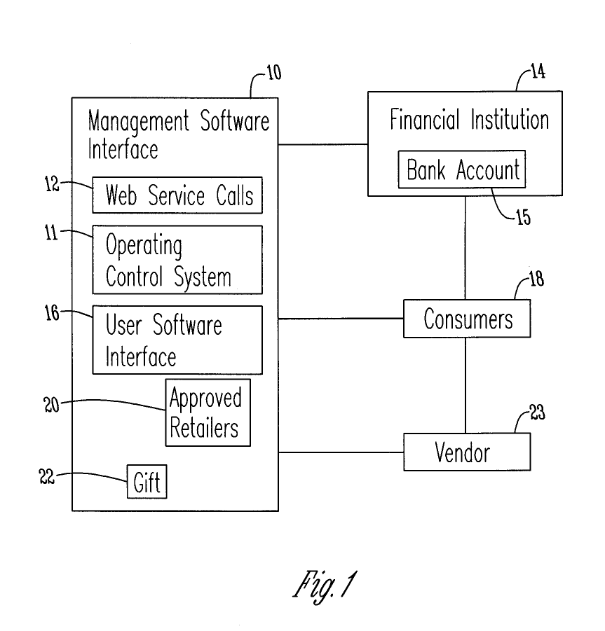

FIG. 2 is a flow diagram of a method of purchasing a gift.

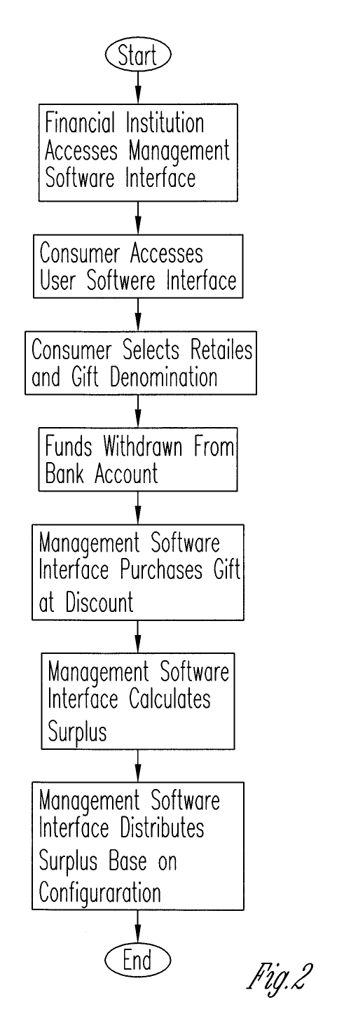

### DETAILED DESCRIPTION OF THE PREFERRED EMBODIMENTS

A method of withdrawal of funds from a bank account 15 to purchase retail gift cards and/or electronic retail gift codes generating cash rewards to consumer and/or revenue to financial institutions involves a web-based management software interface 10 that can be accessed through an electronic network by a series of web service calls 12 by the financial institution 14. The management software interface 10 is connected to an operating central system 11. The management software interface 10 also has a user software interface 16 that can be accessed via the internet by customers 18 of the financial institution 14.

The user software interface 16 allows the consumer 18 to select from a list of approved retailers 20 and to choose the denomination of a gift 22 such as a retail gift card or electronic gift code that they wish to purchase at face value. The management software interface 10 then purchases the retail gift card or electronic gift code 22 from a vendor 23 at a discount. The management software interface 10 then calculates the surplus of funds and divides it between cash back to the consumer 18 and revenue to the financial institution 14.

The management software interface 10 also allows the financial institution 14 via the electronic network to configure the setup and pre-determine how to split the surplus of funds generated between the financial institution 14 and the consumer 18. The financial institution 14 can determine to split the surplus with the consumer 18 at any percentage division, including one party receiving 100% of the surplus.

The management software interface 10 then distributes via the electronic network the surplus of funds between the consumer 18 and the financial institution 14 as previously determined and configured by the financial institution 14.

What is claimed is:

1. A method of purchasing a gift, comprising the steps of:
selecting a gift having a face value by a consumer through a user software interface via the internet and transferring funds via an electronic network to a management software interface;
purchasing the gift by the management software interface at a discount to create a surplus;
configuring the management software interface by financial institution to distribute a portion of the surplus to the consumer and a portion of the surplus to the financial institution; and
distributing the surplus based upon the configuration.

2. The method of clam 1 wherein the selection of a gift is from a list of approved retailers.
